(19) United States
(12) Patent Application Publication
(10) Pub. No.: US 2009/0259622 A1
(43) Pub. Date: Oct. 15, 2009

(54) Classification of Data Based on Previously Classified Data

(76) Inventors: Daniel P. Kolz, Rochester, MN (US); Christopher J. Kundinger, Rochester, MN (US); Taylor L. Schreck, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/101,318

(22) Filed: Apr. 11, 2008

(51) Int. Cl. G06F 7/06; G06F 17/30

(52) U.S. Cl. 707/3; 707/E17.014; 707/E17.046

(57) ABSTRACT

Embodiments of the invention generally provide methods, systems, and articles of manufacture that facilitate classification of unclassified data. When unclassified data records are found in a data tree, one or more classified data records near the unclassified data record in the data tree may be identified. The unclassified data record may be compared to the identified classified data record to determine one or more suggested classifications for the unclassified data record. The unclassified data record may therefore be classified into one of the suggested classifications based on, for example, user input.

### BACKGROUND OF THE INVENTION

1. Field of the Invention

Embodiments of the invention are generally related to data security, and more specifically to classifying data.

2. Description of the Related Art

Modern business organizations maintain and analyze large amounts of data regarding their consumers, consumer behavior, markets in which products are sold, etc. Some of the data maintained by the organizations may be sensitive, for example, consumer social security numbers, bank account numbers, credit card information, and the like. Protection of such sensitive information may be crucial to assuring customers of the organization that their identities are safe. For example, most organizations that offer credit cards implement the Payment Card Industry Data Security Standard (PCI DSS) to prevent credit card fraud and other security vulnerabilities and threats while processing credit card transactions. Data security has also been emphasized by several recent regulations such as the Health Insurance Portability and Accountability Act (HIPAA) and the Sarbanes-Oxley Act. Generally, the data security standards and regulations require that data be provided only on a “need to know” basis. That is, access to data is given only to those individuals that “need to know” the data.

### SUMMARY OF THE INVENTION

The present invention generally relates to data security, and more specifically to classifying data.

One embodiment of the invention provides a computer implemented method for classifying data records. The method generally comprises identifying an unclassified data record in a data tree comprising classified data records, each of the classified data records being classified into at least one of a predefined set of classifications, and selecting one or more classified data records from any one of predecessor nodes and successor nodes of a node comprising the unclassified data record in the data tree. The method further comprises comparing the one or more selected classified data records to the unclassified data record to determine similarities between the one or more selected classified data records and the unclassified data record, and outputting one or more suggested classifications from the predefined set of classifications for the unclassified data record based on the comparison between the one or more selected classified data records and the unclassified data record.

Another embodiment of the invention provides a computer readable storage medium containing a program product which, when executed, performs an operation for classifying data records. The operation generally comprises identifying an unclassified data record in a data tree comprising classified data records, each of the classified data records being classified into at least one of a predefined set of classifications, and selecting one or more classified data records from any one of predecessor nodes and successor nodes of a node comprising the unclassified data record in the data tree. The operation further comprises comparing the one or more selected classified data records to the unclassified data record to determine similarities between the one or more selected classified data records and the unclassified data record, and outputting one or more suggested classifications from the predefined set of classifications for the unclassified data record based on the comparison between the one or more selected classified data records and the unclassified data record.

Yet another embodiment of the invention provides a system, generally comprising a memory and at least one processor. The memory comprises a data classification program configured to classify unclassified data in a data tree comprising classified data records, wherein each of the classified data records are classified into at least one of a predefined set of classifications. The at least one processor, while executing the data classification program, is configured to identify an unclassified data record, and select one or more classified data records from the data tree, wherein the one or more classified data records are selected from any one of predecessor nodes and successor nodes of a node comprising the unclassified data record in the data tree. The processor is further configured to compare the one or more selected classified data records to the unclassified data record to determine similarities between the one or more selected classified data records and the unclassified data record, and output one or more suggested classifications from the predefined set of classifications for the unclassified data record based on the comparison between the one or more selected classified data records and the unclassified data record.

A further embodiment of the invention provides a computer implemented method for classifying data records. The method generally comprises identifying an unclassified data record in a set of data records comprising classified data records, each of the classified data records being classified into at least one of a predefined set of classifications, and selecting one or more of the classified data records from the set, wherein the one or more classified data records are generated by an application that generated the unclassified data record. The method further comprises comparing the one or more selected classified data records to the unclassified data record to determine similarities between the one or more selected classified data records and the unclassified data record, and outputting one or more suggested classifications from the predefined set of classifications for the unclassified data record based on the comparison between the one or more classified data records and the unclassified data record.

Yet another embodiment of the invention provides a computer implemented method for classifying data records. The method generally comprises identifying an unclassified data record in a set of data records comprising classified data records, each of the classified data records being classified into at least one of a predefined set of classifications, and selecting one or more classified data records from the set, wherein the one or more classified data records are received at or near the time the unclassified data record is received. The method further comprises comparing the one or more selected classified data records to the unclassified data record to determine similarities between the one or more selected classified data records and the unclassified data record, and outputting one or more suggested classifications from the predefined set of classifications for the unclassified data record based on the comparison between the one or more selected classified data records and the unclassified data record.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 is a flow diagram of exemplary operations performed while classifying data, according to an embodiment of the invention.

FIG. 3 illustrates an exemplary data tree according to an embodiment of the invention.

FIG. 4 illustrates an exemplary data stream according to an embodiment of the invention.

FIG. 5 illustrates exemplary applications that create data records according to an embodiment of the invention.

### DETAILED DESCRIPTION OF THE PREFERRED EMBODIMENTS

Embodiments of the invention are generally related to data security, and more specifically to classifying unclassified data. When unclassified data records are found in a data tree, one or more classified data records near the unclassified data record in the data tree may be identified. The unclassified data record may be compared to the identified classified data record to determine one or more suggested classifications for the unclassified data record. The unclassified data record may therefore be classified into one of the suggested classifications based on, for example, user input.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplary System

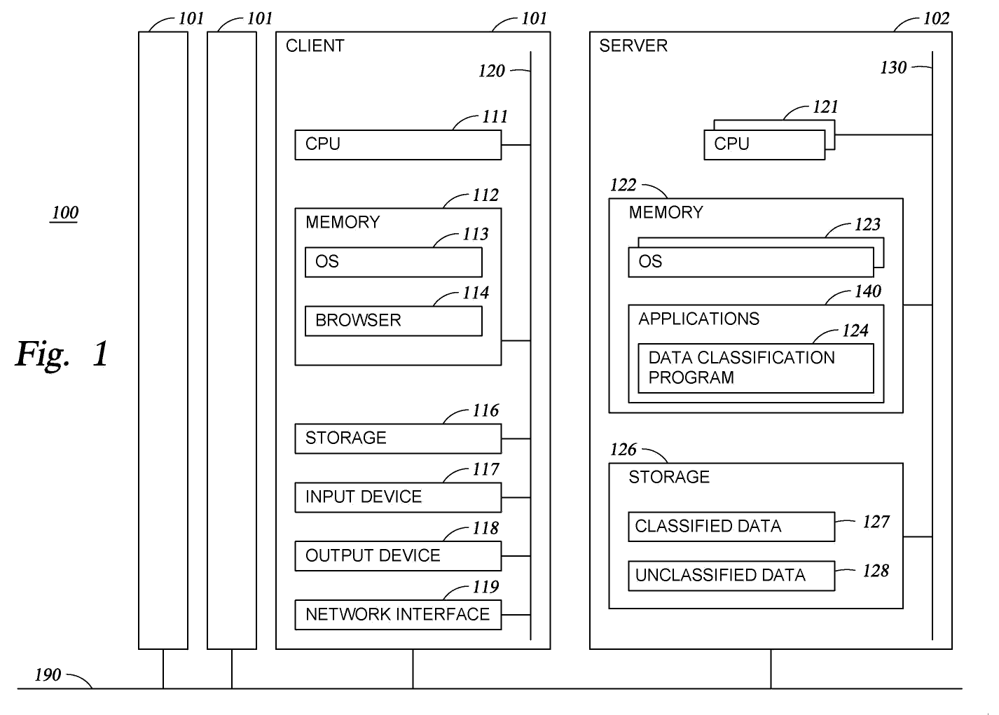

FIG. 1 depicts a block diagram of a networked system 100 in which embodiments of the invention may be implemented. In general, the networked system 100 includes a client (e.g., user's) computer 101 (three such client computers 101 are shown) and at least one server 102 (one such server 102 shown). The client computers 101 and server 102 are connected via a network 190. In general, the network 190 may be a local area network (LAN), a metropolitan area network (MAN), a wide area network (WAN), or the like. In a particular embodiment, the network 190 is the Internet.

The client computer 101 includes a Central Processing Unit (CPU) 111 connected via a bus 120 to a memory 112, storage 116, an input device 117, an output device 118, and a network interface device 119. The input device 117 can be any device to give input to the client computer 101. For example, a keyboard, keypad, light-pen, touch-screen, track-ball, or speech recognition unit, audio/video player, and the like could be used. The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the client computers 101 and server 102 via the network 190. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 112 may include a browser program 114 which, when executed by CPU 111, provides support for browsing content available at a server 102 or another client computer 101. In one embodiment, browser program 114 may include a web-based Graphical User Interface (GUI), which allows the user to display Hyper Text Markup Language (HTML) information. In one embodiment, the GUI may be configured to allow a user to create a search string, request search results from a server 102 or client computer 101, and display search results. More generally, however, the browser program 114 may be a GUI-based program capable of rendering any information transferred from a client computer 101 and/or server 102.

The server 102 may by physically arranged in a manner similar to the client computer 101. Accordingly, the server 102 is shown generally comprising at least one CPU 121, memory 122, and a storage device 126, coupled with one another by a bus 130. Memory 122 may be a random access memory sufficiently large to hold the necessary programming and data structures that are located on server 102.

In one embodiment, server 102 may be a logically partitioned system, wherein each logical partition of the system is assigned one or more resources, for example, CPUs 121 and memory 122, available in server 102. Accordingly, in one embodiment, server 102 may generally be under the control of one or more operating systems 123 shown residing in memory 122. Each logical partition of server 102 may be under the control of one of the operating systems 123. Examples of the operating system 123 include IBM OS/400®, UNIX, Microsoft Windows®, and the like. More generally, any operating system capable of supporting the functions described herein may be used.

The memory 122 further includes one or more applications 140. The applications 140 may be software products comprising a plurality of instructions that are resident at various times in various memory and storage devices in the computer system 100. When read and executed by one or more processors 121 in the server 102, the applications 140 may cause the computer system 100 to perform the steps necessary to execute steps or elements embodying the various aspects of the invention. In one embodiment, the applications 140 may include a data classification program 124, which is discussed in greater detail below.

Storage 126 may include data that is accessed by and operated on by the applications 140. In one embodiment, the access and modification of data in the storage device 126 may be performed by the applications 140 in response to user input. For example, a user may initiate the browser program 114 and access or modify data in the storage device 126 via an application 140. The application 140 may be configured to display the data in the browser program 114 to facilitate user access and modification.

In one embodiment of the invention, storage 126 may include classified data 127 and unclassified data 128. Classified data may include data records that have associated metadata describing the data. For example, in one embodiment, classified data 127 may include metadata that describes accessibility of the data. Accessibility of data in the storage device 126 may be restricted for various reasons. For example, a data security standard such as the PCI DSS standard, or a regulation such as the Sarbanes Oxley Act, may require that the data in the storage device 126 be only be displayed to particular individuals based on, for example, the sensitivity of the data. Accordingly, in some embodiments, the metadata may describe the sensitivity of the data.

In one embodiment of the invention, data classification may involve classifying data into one or more security levels. Exemplary data classification may include, for example, Level 1 data, Level 2 data, Level 3 data, and the like, wherein the level numbers indicate an increasing or decreasing sensitivity of the data. Alternatively, a color code, alphabet code, or the like may also be used to classify the data.

In one embodiment, metadata used to classify data may include a description of a type of individuals having access to the data. For example, an organization may include several departments such as human resources, accounting, sales, engineering, and the like. Each department may have data associated with the department and accessible only to members of the department. Accordingly, in one embodiment, the data may be classified as, for example, human resources data, accounting data, sales data, engineering data, and the like. In some embodiments, access to data may be determined by a designation (or role) of an individual within an organization. For example, access to data may be determined based on whether an individual is a president, vice president, director, manager, employee, janitor, in the organization. Accordingly, the data may be classified based on the designations, for example, director data, manager data, employee data, and the like.

In some embodiments, each record of data may include more than one classification. For example, data that may be accessed by employees may also be accessed by managers. Accordingly, a given record of data may be classified as both, employee data and manager data, in one embodiment.

Unclassified data 128 may include data that is yet to be classified. For example, unclassified data may include data that is created by a user using client computer 101 or by an application 140 and stored in the storage 126, wherein the user or application did not include a classification for the data.

In one embodiment, the unclassified data 128 may include sensitive information. For example, a person applying for a credit card may create unclassified data 128 including, for example, his/her social security number. The person creating the sensitive unclassified data 128 may not include metadata describing accessibility of the data. Therefore, the unclassified data 128 may have to be classified at a later time.

Traditionally, classification of unclassified data has been a manual process in which one or more individuals find, analyze, and classify each record of unclassified data 128 in the storage 126. However, this process may be tedious, inefficient, and time consuming. For example, the classified data 127 and 128 may exist at various locations of a data tree. For example, the classified data 127 and unclassified data 128 may exist in various directories and folders of a directory tree. Therefore, in order to classify unclassified data, an individual may have to view each folder in the directory tree, identify unclassified data, and classify the data. This process may be extremely tedious and time consuming. Furthermore, manual classification may result in exposing sensitive data to individuals not authorized to view the data, i.e., the person performing the classification. Additionally, the classification may be prone to human error.

In one embodiment of the invention, data contained in the storage device 126 may be either structured data or unstructured data. Structured data records may include data that is related based one or more predefined relations, schema, attributes, and the like. For example, a table or spreadsheet may be organized into rows and columns, and may include one or more fields that define a particular type of data. For example, a spreadsheet may have a first column containing first names, a second column containing last names, a third column containing addresses, and the like. Structured data may also include linked lists, binary trees, and the like. Unstructured data may be any data without structure, for example, images, text files, sound files, and the like. In other words, there may be no predefined relationship between data within an unstructured data record.

While the classification program 124, classified data 127, and unclassified data 128 are shown as being within the storage device 126 of server 102, in alternative embodiments, the classification program 124, classified data 127, and unclassified data 128 may be contained in any device in the system 100, for example, memory 122 of server 102, memory 112 or storage 116 of client computer 101, and the like. Furthermore, while embodiments are described herein with respect to a client/server model, this model is merely used for purposes of illustration. Persons skilled in the art will recognize other communication paradigms, all of which are contemplated as embodiments of the present invention. As such, the terms “client” and “server” are not to be taken as limiting.

### Identifying Related Classified Data

Embodiments of the invention provide a computer implemented method for classifying unclassified data, thereby obviating the tedious and time consuming manual classification process. In one embodiment, the data classification program 124 may be configured to detect unclassified data records 128 and identify one or more categories into which the data may be classified. The data classification program may be configured to determine the one or more categories based on one or more classified data records 127, as will be discussed in greater in the next section.

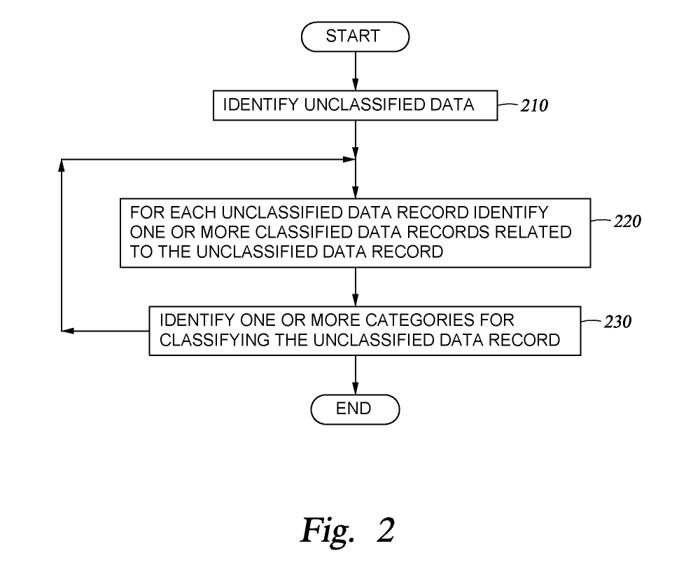

FIG. 2 is a flow diagram of exemplary operations that may be performed by the data classification program 124 to classify unclassified data. The operations may begin in step 210 by identifying one or more unclassified data records, for example, in the storage device 126. In one embodiment of the invention, the data classification program may be initiated by user input. For example, a system administrator may initiate the data classification program 124 to facilitate classification of the unclassified data 128. In alternative embodiments, the data classification program 128 may be configured to monitor modification and creation of data in the storage device 126 and identify unclassified data records as they are created. In other embodiments, the data classification program may be configured to automatically initiate a search for unclassified data after a predetermined time period, for example, after every hour.

In step 220, for each unclassified data record that is found, the data classification program may identify one or more classified data records related to the unclassified data record. The data classification program 124 may select the one or more classified data records based on any reasonable relationship between the unclassified records and the classified data records.

For example, in one embodiment, the classified data records may be selected based on a spatial proximity of the classified data records to the unclassified data record in a data tree. For example, in one embodiment, data may be stored in a directory tree including one or more folders and subfolders. In one embodiment, classified data in the same folder as the unclassified data, and/or data in a parent or child folder of the folder containing the unclassified data may be selected by the data classification program.

In some embodiments, the data classification program may be configured to select classified data within a threshold distance from the unclassified data. For example, in one embodiment, the data classification program 124 may only search for classified data records within a predetermined number of levels from the unclassified data record in the data tree. For example, in a directory tree, the data classification program 124 may only search predetermined levels of parent folders and/or child folders to identify the classified data records.

In step 230, the data classification program may identify one or more categories for classifying the unclassified data record based on the identified one or more classified data records. For example, in one embodiment, if the one or more classified data records are classified as director data, the unclassified data record may also be classified as director data. The classification of unclassified data based on the identified one or more classified data records is described in greater detail in the next section. The remainder of this section provides exemplary methods for identifying related classified data.

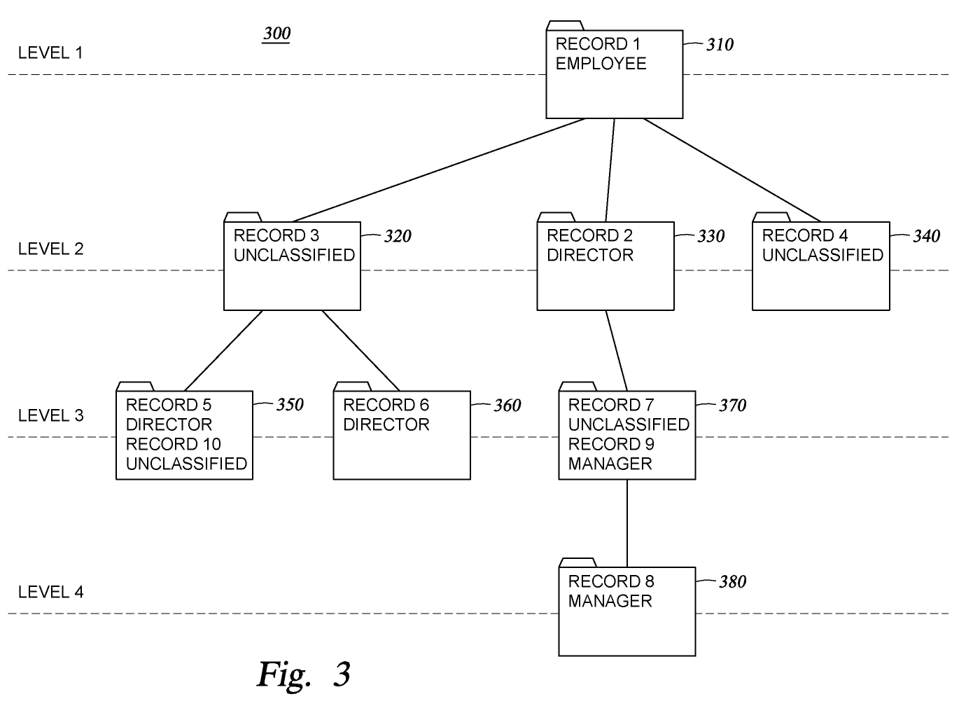

FIG. 3 illustrates an exemplary data tree 300 according to an embodiment of the invention. Data tree 300 may include a plurality of hierarchically arranged nodes, for example, the nodes 310-380. In one embodiment, the data tree 300 may be a directory tree wherein the nodes 310-380 represent hierarchically arranged folders 310-380. Each folder may contain one or more records which may or may not be classified. In one embodiment, the data classification program 124 may be configured to identify unclassified records in the data tree 300 and identify one or more classified data records that are related to the unclassified data record. For example, in a particular embodiment, the data classification program may identify classified records that are within a predetermined proximity to the unclassified data record in the data tree.

In one embodiment, the data classification program 124 may be configured to identify one or more classified data records in the same folder as the unclassified data record. For example, record 7 in folder 370 is an unclassified record, as illustrated in FIG. 3. Folder 370 also includes record 9, which is classified as manager data. Accordingly, record 9 may be selected as a data record related to record 7 and ‘manager data’ may be a potential category for classifying record 7.

In one embodiment, data classification program may identify one or more classified records in any one of a predecessor folder and a successor folder of the folder containing the unclassified record. For example, the folder 370 has one parent folder 330 and one child folder 380. Accordingly, in some embodiments, the data classification program 124 may be configured to search the parent folder 330 and the child folder 380 for classified data records. As can be seen in FIG. 3, folder 330 includes a record 2 that is classified as ‘director data’ and folder 380 includes a record 8 that is classified as ‘manager data’. Accordingly, the data classification program may identify record 2 as a related record and ‘director data’ and ‘manager data’ as potential categories for classifying the record 7.

As illustrated in FIG. 3, the data tree 300 may include a plurality of levels. For example, folder 330 is shown as being in level 2 and folder 380 is shown in level 4 of the data tree 300. While, in the previous example, searching one level above and one level below folder 370 containing the unclassified record 7 is discussed, in alternative embodiments, predecessors and successors in any number of levels above and below the folder 370 may be searched for classified records. In some embodiments, the data classification program 124 may be configured to search a threshold number of levels above and/or below the folder containing the unclassified record. For example, if a threshold of two is used, data classification program 124 may also search folder 310 for classified records. Accordingly, record 1 may be identified as a related record and the potential categories for record 7 may include ‘employee data’, ‘director data’, and ‘manager data’.

In some embodiments of the invention, data classification program 124 may be configured to search for classified records in the same level as a folder containing the unclassified record. For example, level 3 in the data tree 300 includes folders 350, 360, and 370. Accordingly, in one embodiment, data classification program 124 may be configured to search folders 360 and 370 while classifying record 7. Because the folders 350 and 360 contain records 5 and 6, respectively, records 5 and 6 may be identified as related to record 7.

In one embodiment, data classification program 124 may be configured to search for classified records in a parent folder and any child folders of the parent folder. For example, folder 350 includes an unclassified record 10. To determine categories for classifying record 10, data classification program 124 may be configured to search for classified records in folders 320 and 360. Embodiments of the invention are not limited to the specific examples for identifying classified records described hereinabove. Any reasonable algorithm for identifying one or more related folders and classified records therein based on the hierarchy of the data tree 300 fall within the purview of the invention.

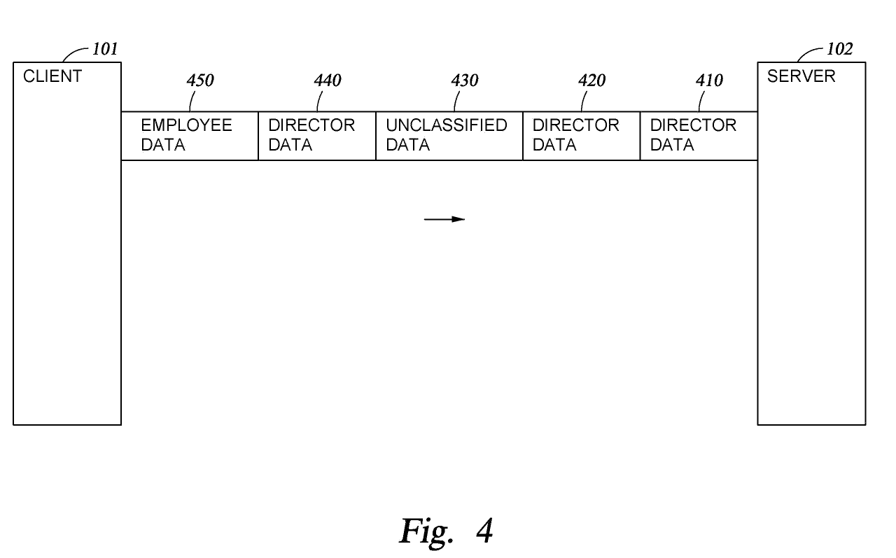

In an alternative embodiment of the invention, data classification may be based on a temporal proximity of unclassified data to one or more classified data records. For example, referring back to FIG. 1, server 102 may receive a stream of data records that may be stored in the storage device 126. The stream of data records may include classified data records and unclassified data records. FIG. 4 illustrates an exemplary stream of data records sent from a client computer 101 to a server 102. The stream of data records may include data records 410-450. As illustrated in FIG. 4, data records 410, 420, and 440 may be classified as director data, record 450 may be classified as employee data, and record 430 may be unclassified.

In one embodiment, any number of classified records received before and/or after an unclassified data record may be identified as data records related to the unclassified data. Because the unclassified data record 430 is received before or after receiving records classified as ‘director data’ as indicated in FIG. 4, the potential categories for classifying data record 430 may include ‘director data’.

In some embodiments, the data classification program may be configured to monitor data records received either before or after a predetermined time from the time the unclassified data record is received. Data records received within the predetermined period of time may be identified as data records related to the unclassified data record.

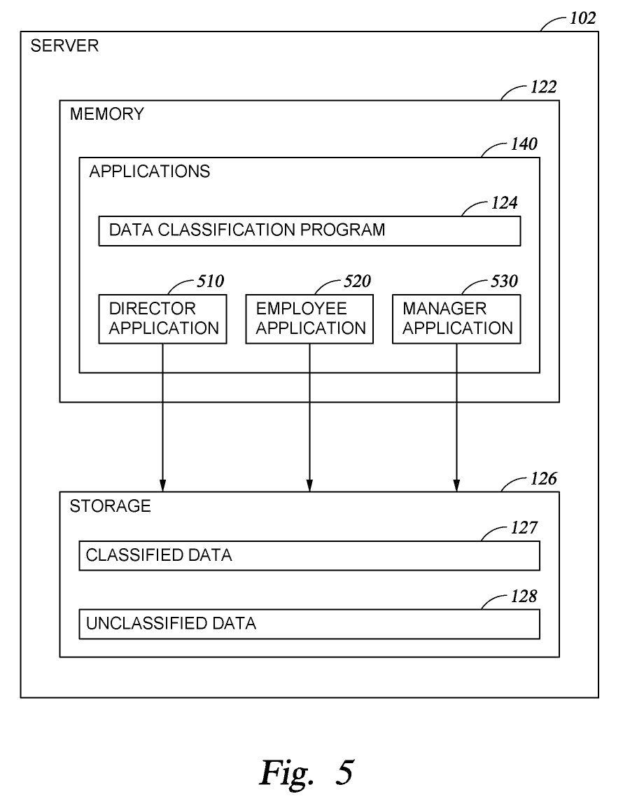

In some embodiments, data classification program may classify data records based on an application 140 that created the data record. FIG. 5 illustrates a plurality of applications 140, for example, director application 510, employee application 520, and manager application 530. Director application 510 may generally provide a service to a director. Therefore, the director application 510 may generally generate director data. Similarly, the employee application 520 may generate employee data, and the manager application 530 may generate manager data.

Therefore, the data classification program 124 may be configured to monitor generation of data by the one or more applications 140 and classify unclassified data records based on one or more other records generated by a particular application. For example, in one embodiment, the director application 510 may generate a classified data record and an unclassified data record. Because the classified data record is generated by the same application as the unclassified data record, the classified data record may be identified as related to the unclassified data record.

### Analysis of Classified and Unclassified Data

The data classification program 124 may identify several classified data records using any one or a combination of the methods outlined in the previous section. After the related classified data records are identified, the related classified data records and the unclassified data records may be analyzed to identify one or more categories into which the unclassified data record may be classified.

In one embodiment of the invention, the analysis of the related classified data records and the unclassified data record may depend on whether the data records are structured data records or unstructured data records. Structured data records may include data organized on the basis of one or more definitions, schema, attributes, and the like. Exemplary structured data records may include tables, spreadsheets, linked lists, and the like.

In some embodiments, the structured data may include one or more field or attribute definitions. Accordingly, analyzing the related classified data records and the unclassified data records may involve comparing the field or attribute definitions in the unclassified data record and a related classified data record. For example, in one embodiment, the unclassified data record may be a table containing a column containing social security numbers. If a related classified data record also includes a table with a column containing social security numbers, it may be likely that the unclassified data record has the same classification as the related classified data record. Therefore, the classification of the related classified data record containing social security numbers may be included as a potential classification for the unclassified data record.

If the data in the unclassified data record in unstructured data, data classification program 124 may be configured to determine if the content of one or more related classified data is similar to the content of the unclassified data record. In one embodiment, the data classification program may be configured to analyze the unclassified data record and the related classified data records by identifying one or more key words in the records. The key words may include, for example, section titles, or any other predetermined key words.

For example, in one embodiment, the unclassified data record may include the word ‘CONFIDENTIAL’. If one of more related classified data records also contain the word ‘CONFIDENTIAL’, it may be likely that the unclassified data record has the same classification as the classified data records containing the word ‘CONFIDENTIAL’. Accordingly, the classifications of such classified data records may be identified as potential classifications for the unclassified data record.

In one embodiment of the invention, the potential classifications for a given unclassified data record may be displayed to a user, for example, in the browser program 114 illustrated in FIG. 1, to facilitate user selection of one of the suggested classifications. In some embodiments, for each of the suggested classifications, the data classification program may be configured to determine a probability that the unclassified data record belongs to a given classification. The probability may be computed based on the analysis of the unclassified data record and the related classified data records as discussed above. The probability may be displayed to a user to facilitate selection of an appropriate classification for the unclassified data record.

In some embodiments, if a user determines that the suggested classifications are inaccurate, the user may be allowed to enter his/her own classification of the unclassified data record. Alternatively, the user may be allowed to request reanalysis of the unclassified data record and related classified data records for a new set of classification suggestions. While requesting the reanalysis, the user may be allowed to alter one or more parameters for identifying related classified documents and/or for analysis. For example, the user may be allowed to expand (or contract) a number of levels searched to identify related classified documents, identify key words or field names to be compared during reanalysis, and the like.

In some embodiments of the invention, user input may not be required for classification of unclassified data. For example, the data classification program may be configured to classify the unclassified data record based on, for example, the probabilities calculated during the analysis.

In one embodiment, once the unclassified data has been classified, the data may be used to classify other unclassified data. For example, the previously unclassified data may be identified as related classified data of another unclassified data record and analyzed to retrieve suggested classifications.

### CONCLUSION

By providing an automated method for identifying and classifying unclassified data based on related classified data, embodiments of the invention make data classification more efficient and promote data security.

While the foregoing is directed to embodiments of the present invention, other and further embodiments of the invention may be devised without departing from the basic scope thereof, and the scope thereof is determined by the claims that follow.

What is claimed is:

1. A computer implemented method for classifying data records, comprising:
identifying an unclassified data record in a data tree comprising classified data records, each of the classified data records being classified into at least one of a predefined set of classifications;
selecting one or more classified data records from any one of predecessor nodes and successor nodes of a node comprising the unclassified data record in the data tree;
comparing the one or more selected classified data records to the unclassified data record to determine similarities between the one or more selected classified data records and the unclassified data record; and
outputting one or more suggested classifications from the predefined set of classifications for the unclassified data record based on the comparison between the one or more selected classified data records and the unclassified data record.

2. The method of claim 1, wherein one or more classified data records are selected from predecessor nodes and successor nodes within a predetermined number of levels from the node comprising the unclassified data record.

3. The method of claim 1, further comprising selecting the one or more classified data records from a successor node of a predecessor node of the node comprising the unclassified data record.

4. The method of claim 1, further comprising selecting the one or more classified data records from one or more nodes of the data tree that are in a same level as a node comprising the unclassified data record.

5. The method of claim 1, wherein determining similarities between the one or more selected classified data records and the unclassified data record comprises determining whether the one or more selected classified data records and the unclassified data records include similar structure.

6. The method of claim 1, wherein determining similarities between the one or more selected classified data records and the unclassified data record comprises determining whether the one or more selected classified data records and the unclassified data records include similar content.

7. The method of claim 1, further comprising receiving user input selecting at least one of the one or more suggested classifications for the unclassified data record, and classifying the unclassified data record based on the user input.

8. A computer readable storage medium containing a program product which, when executed, performs an operation, comprising:
identifying an unclassified data record in a data tree comprising classified data records, each of the classified data records being classified into at least one of a predefined set of classifications;
selecting one or more classified data records from any one of predecessor nodes and successor nodes of a node comprising the unclassified data record in the data tree;
comparing the one or more selected classified data records to the unclassified data record to determine similarities between the one or more selected classified data records and the unclassified data record; and
outputting one or more suggested classifications from the predefined set of classifications for the unclassified data record based on the comparison between the one or more selected classified data records and the unclassified data record.

9. The computer readable storage medium of claim 8, wherein the operation comprises selecting the one or more classified data records from predecessor nodes and successor nodes within a predetermined number of levels from the node comprising the unclassified data record.

10. The computer readable storage medium of claim 8, wherein the operation further comprises selecting the one or more classified data records from a successor node of a predecessor node of the node comprising the unclassified data record.

11. The computer readable storage medium of claim 8, wherein the operation further comprises selecting the one or more classified data records from one or more nodes of the data tree that are in a same level as a node comprising the unclassified data record.

12. The computer readable storage medium of claim 8, wherein determining similarities between the one or more selected classified data records and the unclassified data record comprises determining whether the one or more selected classified data records and the unclassified data records include similar structure.

13. The computer readable storage medium of claim 8, wherein determining similarities between the one or more selected classified data records and the unclassified data record comprises determining whether the one or more selected classified data records and the unclassified data records include similar content.

14. The computer readable storage medium of claim 8, further comprising receiving user input selecting at least one of the one or more suggested classifications for the unclassified data record, and classifying the unclassified data record based on the user input.

15. A system, comprising:
memory comprising a data classification program configured to classify unclassified data in a data tree comprising classified data records, wherein each of the classified data records are classified into at least one of a predefined set of classifications; and
at least one processor, wherein each processor, while executing the data classification program, is configured to:
identify an unclassified data record;
select one or more classified data records from the data tree, wherein the one or more classified data records are selected from any one of predecessor nodes and successor nodes of a node comprising the unclassified data record in the data tree;
compare the one or more selected classified data records to the unclassified data record to determine similarities between the one or more selected classified data records and the unclassified data record; and
output one or more suggested classifications from the predefined set of classifications for the unclassified data record based on the comparison between the one or more selected classified data records and the unclassified data record.

16. The system of claim 15, wherein the processor is configured to select the one or more classified data records from predecessor nodes and successor nodes within a predetermined number of levels from the node comprising the unclassified data record.

17. The system of claim 15, wherein the processor is configured to select the one or more classified data records from a successor node of a predecessor node of the node comprising the unclassified data record.

18. The system of claim 15, wherein the processor is configured to select the one or more classified data records from one or more nodes of the data tree that are in a same level as a node comprising the unclassified data record.

19. The system of claim 15, wherein the processor is configured to determine similarities between the one or more selected classified data records and the unclassified data record by determining whether the one or more selected classified data records and the unclassified data records include similar structure.

20. The system of claim 15, wherein the processor is configured to determine similarities between the one or more selected classified data records and the unclassified data record by determining whether the one or more selected classified data records and the unclassified data records include similar content.

21. The system of claim 15, wherein the processor is further configured to receive user input selecting at least one of the one or more suggested classifications for the unclassified data record, and classify the unclassified data record based on the user input.

22. A computer implemented method for classifying data records, comprising:
identifying an unclassified data record in a set of data records comprising classified data records, each of the classified data records being classified into at least one of a predefined set of classifications;
selecting one or more of the classified data records from the set, wherein the one or more classified data records are generated by an application that generated the unclassified data record;
comparing the one or more selected classified data records to the unclassified data record to determine similarities between the one or more selected classified data records and the unclassified data record; and
outputting one or more suggested classifications from the predefined set of classifications for the unclassified data record based on the comparison between the one or more classified data records and the unclassified data record.

23. A computer implemented method for classifying data records, comprising:
identifying an unclassified data record in a set of data records comprising classified data records, each of the classified data records being classified into at least one of a predefined set of classifications;
selecting one or more classified data records from the set, wherein the one or more classified data records are received at or near the time the unclassified data record is received;
comparing the one or more selected classified data records to the unclassified data record to determine similarities between the one or more selected classified data records and the unclassified data record; and
outputting one or more suggested classifications from the predefined set of classifications for the unclassified data record based on the comparison between the one or more selected classified data records and the unclassified data record.
